(19) United States
(12) Patent Application Publication
(10) Pub. No.: US 2025/0170522 A1
(43) Pub. Date: May 29, 2025

(54) SOLID DESICCANT RESISTANT TO ALKALI HYDROXIDES

(71) Applicant: ARKEMA FRANCE, COLOMBES (FR)

(72) Inventors: Ugo RAVON, Lacq (FR); Cecile LUTZ, Lacq (FR); Isabelle GLAUDEIX, Lacq (FR); Sylvie SZENDROVICS, Lacq (FR)

(21) Appl. No.: 18/725,569

(22) PCT Filed: Dec. 19, 2022
(86) PCT No.: PCT/FR2022/052419

§ 371 Date: Jun. 28, 2024

(30) Foreign Application Priority Data
Dec. 30, 2021 (FR) 2114669

(51) Int. Cl. B01D 53/26; B01D 53/02; B01D 53/28; B01J 20/18; B01J 20/28; C01B 3/56

(52) U.S. Cl. CPC B01D 53/261; B01D 53/02; B01D 53/28; B01J 20/18; B01J 20/2803; C01B 3/56; B01D 2253/108; B01D 2256/16; B01D 2257/80; C01B 2203/042

(57) ABSTRACT

The present invention relates to the use, for the drying of wet gas comprising traces of alkaline hydroxide, of a solid desiccant comprising at least one kaolin compound.

The invention also relates to the process for drying wet gas comprising traces of alkaline hydroxide, comprising at least one stage of bringing said wet gas into contact with a solid desiccant comprising at least one kaolin compound.

The present invention relates to the field of the production of molecular hydrogen and in particular to the production of dry molecular hydrogen and more specifically to the production of molecular hydrogen dried over a molecular sieve.

The generation of molecular hydrogen by basic electrolysis is a technology which is now well known and sufficiently developed to be able to form the subject of major installations of production units. In this basic electrolysis process, water is converted into molecular hydrogen and molecular oxygen under the action of an electric current. As in any type of electrolysis, an electrolyte is often necessary to facilitate ion transfer in the solution to be electrolysed.

Different electrolytes can thus be employed, and very particularly basic electrolytes will be selected here, in particular electrolytes based on alkali metal hydroxides, and very particularly sodium hydroxide and potassium hydroxide. One of the most effective electrolytes consists of aqueous potassium hydroxide, or KOH, solutions.

In a basic electrolysis process, molecular hydrogen is obtained on the cathode by the reduction of two protons. The gaseous molecular hydrogen thus recovered is wet, that is to say that it contains more or less significant traces of water. In addition, the wet molecular hydrogen recovered possibly, but generally, contains traces of alkaline hydroxide and, for example, traces of potassium hydroxide.

In point of fact, it turns out that such traces of alkaline hydroxide can be harmful to the drying solids, which solids appear among the preferred solutions for the drying of molecular hydrogen resulting from electrolysis. Numerous fields of application require the use of dry molecular hydrogen and in particular of molecular hydrogen which has undergone a treatment over a drying solid. It might thus be envisaged to remove any trace of alkaline hydroxide present in the molecular hydrogen to be dried and to maintain good production of dry molecular hydrogen exhibiting the greatest possible purity. Before being used, the molecular hydrogen consequently has to be purified but the presence of potassium hydroxide, a strong base, greatly limits the range of sieves which can be used.

The different techniques conventionally used today for the drying of gases are well known to a person skilled in the art. Thus, wet gases are normally dried by different techniques, for example by membrane permeation, by washing operations on the gases with formulations based on organic compounds, for example based on glycol.

Furthermore, the use is known of solid desiccants, such as, for example, activated aluminas, silica gels or molecular sieves, for the drying of organic liquids or of gases, such as described, for example, in Patent EP 1 597 197 B1, where zeolite 3A agglomerates make possible the drying of esters and alcohols. Thus, wet molecular hydrogen is today generally dried by means of solid desiccants. Zeolite agglomerates, also known as molecular sieves, are among the most efficient desiccating agents and make it possible to achieve very low residual water contents of the order of a part per million.

This extreme ability to adsorb water molecules is one of the characteristics of zeolites, which are aluminosilicates of controlled crystallinity. However, and in order to be able to be used in industrial processes, zeolite crystals, which exist in the form of a very fine powder, have to be shaped in order to be able to be handled more easily, for example in the form of beads or threads.

In order to shape these zeolite crystals, and as the agglomerating power of zeolites is very low, it is necessary to use binders, referred to as agglomeration binders. These agglomeration binders are generally binders of clay type and are today well known and commonly used to control the final shape of zeolite agglomerates.

Nevertheless, it remains the case that these clay-based agglomeration binders are most of the time very sensitive to the action of inorganic bases, such as sodium hydroxide or potassium hydroxide, and others. This fragility results in molecular sieves which risk not being sufficiently stable under the conditions of drying of gases originating from electrolyses employing basic electrolytes, in particular electrolytes based on alkali metal hydroxide, and very particularly electrolytes based on sodium hydroxide and on potassium hydroxide.

The technical problem which the present invention proposes to solve is thus that of the provision of a solid desiccant which is intended for the drying of wet gases produced by basic electrolysis and which is resistant to the traces of alkaline hydroxides present in said wet gases. Another objective of the present invention is to make available solid desiccants which are resistant to the traces of potassium hydroxide present in wet gases. Yet another objective of the present invention is the provision of a solid desiccant resistant to the traces of potassium hydroxide present in wet hydrogen produced by basic hydrolysis, in which the basic electrolyte comprises potassium hydroxide.

It has now been discovered that the abovementioned objectives are achieved, in all or at least in part, by virtue of the subject-matter of the invention which will now be set out. Yet other objectives will become apparent in the continuation of the description. Specifically, it has been discovered entirely surprisingly by the inventors that specific solid desiccants can be used for the drying of wet gases, without undergoing significant degradation, even in the presence of traces of basic compounds, such as alkaline hydroxides.

Thus, and according to a first aspect, the present invention relates to the use, for the drying of wet gas comprising traces of alkaline hydroxide, of a solid desiccant comprising at least one kaolin compound.

The wet gas which can be dried using the abovementioned solid desiccant can be of any type well known to a person skilled in the art and, for example and without implied limitation, the gas is chosen from industrial gases, such as nitrogen, oxygen, hydrogen, rare gases, carbon dioxide and their mixtures, and in particular hydrogen, optionally as a mixture with one or more of the other gases listed above, and very particularly hydrogen obtained by electrolysis in a basic medium.

The moisture content of the gas to be dried in the context of the use of the present invention can vary within wide proportions, in particular depending on the nature of the gas to be dried (wet gas) and on the nature of the solid desiccant used. As a general rule, the moisture content is of between 5 ppm by volume and 2% by volume. The term “moisture content” is understood to mean the amount by volume of water contained in the gas to be dried.

The use according to the present invention is particularly well suited to wet gases which comprise traces of alkaline hydroxide, such as lithium hydroxide, sodium hydroxide, potassium hydroxide and their mixtures, more particularly sodium hydroxide, potassium hydroxide and their mixtures, more specifically traces of potassium hydroxide. The term “traces” is understood more specifically to mean contents of between 1 ppm and 1000 ppm, preferably between 1 ppm and 500 ppm, by volume.

The solid desiccant which forms the subject-matter of the use according to the present invention can be of any type well known to a person skilled in the art and, by way of non-limiting examples, can be chosen from activated aluminas, silica gels, molecular sieves and others, and also their mixtures in all proportions. Preference is very particularly given to molecular sieves and, among these, to zeolite agglomerates and more specifically to zeolite agglomerates comprising crystals of zeolite(s) and at least one kaolin compound.

According to a particularly preferred embodiment of the use of the present invention, the kaolin compound is a kaolin binder which will bind together the crystals of zeolite(s) in order to confer cohesion on said zeolite agglomerate. Such zeolite agglomerates having a kaolin binder are very well known to a person skilled in the art and are commercially available or can be prepared according to known procedures available in the scientific literature and the patent literature and also on the Internet.

According to one embodiment of the invention, the solid desiccant is a zeolite agglomerate comprising from 70% to 99.99%, preferably from 70% to 99.9%, more preferably from 80% to 99.9%, by weight, limits included, of crystals of at least one zeolite chosen from zeolites of LTA type, zeolites of FAU type, zeolites of SOD type, zeolites of P type, and their mixtures, and preferably from zeolites 3A, 4A, 5A, 13X, and their mixtures, more preferably from zeolites 3A and 4A, and their mixtures.

The zeolite agglomerate which can be used in the context of the present invention can in addition comprise crystals of one or more zeolites, other than those already listed above. However, it is preferred to use zeolite agglomerates, the crystals of zeolites of which are perfectly well suited to drying operations on gases, for example zeolites 3A, 4A, 5A, 13X, and their mixtures, more preferably zeolites 3A and 4A, and their mixtures.

As indicated above, the kaolin compound is advantageously a kaolin binder. The term “kaolin binder” is understood to mean a kaolin clay or a kaolin clay precursor and more particularly a clay chosen from kaolins, kaolinites, nacrites, dickites, halloysites and metakaolins, and their mixtures.

The zeolite agglomerate which can be used in the context of the present invention can also comprise one or more other binders but also one or more inert fillers, with the aim of further strengthening the cohesion of the solid desiccant, of modifying its density, of creating porosity. Mention may be made, among the other possible agglomeration binders, for example, of bentonite, without this example being limiting. Mention may be made, among the possible inert fillers, for example, without implied limitation, of sources of silica of any type known to the person skilled in the art who is a specialist in the synthesis of zeolites, such as colloidal silica, diatomaceous earths, perlite, fly ash, sand or any other form of solid silica, but also glass fibres, carbon fibres, carbon nanotubes, and others, and their mixtures.

According to a preferred embodiment, the other binders and/or inert fillers do not represent more than 33% by weight, with respect to the total weight of the kaolin compounds, of the other binders and of the fillers.

The kaolin compound can furthermore comprise one or more additives, preferably organic additives, for example lignin, starch, methylcelluloses and their derivatives, surface-active (cationic, anionic, non-ionic or amphoteric) molecules, intended to facilitate the preparation of the solid desiccant, in particular the handling of the zeolite(s)/kaolin compound(s) paste by modification of the rheology and/or of the tackiness, or to confer satisfactory properties, in particular of macroporosity, on the solid desiccant. They are introduced during the preparation of the solid desiccant in a proportion of 0% to 5%, preferably of 0.1% to 2%, by weight, with respect to the total weight of the adsorbent.

Mention may be made, preferentially but non-exhaustively, of methylcelluloses and their derivatives, such as carboxymethylcellulose, lignosulfonates, polycarboxylic acids and carboxylic acid copolymers, their amino derivatives and their salts, in particular the alkaline salts and the ammonium salts.

In yet another preferred embodiment, the kaolin compound can be, in all or in part, and preferentially in part, zeolitized, that is to say that all or a part respectively of the kaolin compound, or kaolin binder, is converted into zeolite substance, either before use, or during use, or before and during use. The zeolitization can be carried out by any means well known to a person skilled in the art and for example as described in EP 1 697 042. The zeolitization can also be carried out, under certain conditions, during the actual use of drying the gas. Without wishing to be committed to a theory, it is believed that the presence of traces of alkaline hydroxide, optionally in combination with rises in temperature, at least locally, in the solid desiccant, can result in an at least partial zeolitization of the kaolin compound or binder.

It has thus been discovered that solid desiccants comprising a zeolite compound withstand particularly well the presence of traces of alkaline hydroxides, in particular of traces of potassium hydroxide, present in wet molecular hydrogen to be dried, in particular in molecular hydrogen obtained by electrolysis. The solid desiccants comprising a kaolin compound withstand particularly well and in particular better than solid desiccants commonly used and known today for the drying of gases.

Thus, the use of the present invention is particularly suitable for zeolite agglomerates having a kaolin binder and very particularly for zeolite agglomerates based on zeolite 3A, 4A, 5A and/or 13X comprising kaolin as agglomeration binder which can be completely or at least partially zeolitized, and preferably for agglomerates based on zeolite 3A and/or 4A, having a kaolin binder, which is non-zeolitized or partially or completely zeolitized.

According to a second aspect, the present invention relates to a process for drying wet gas comprising traces of alkaline hydroxide, comprising at least one stage of bringing said wet gas into contact with a solid desiccant comprising at least one kaolin compound as just defined.

The operation of bringing said wet gas into contact with the solid desiccant can be carried out according to any method well known to a person skilled in the art and in particular in an adsorber, which is, for example and generally, a column containing the solid desiccant.

The process of the invention can be carried out according to various techniques and methods and for example according to a process chosen from:
pressure swing processes, for example of PSA (Pressure Swing Adsorption) type or of VSA (Vacuum Swing Adsorption) type or of VPSA (hybrid process of the two preceding ones) type or of RPSA (Rapid Pressure Swing Adsorption) type, preferably of PSA type,
temperature swing processes of TSA (Temperature Swing Adsorption) type, and
pressure and temperature swing processes of PTSA (Pressure and Temperature Swing Adsorption) type.

The wet gas intended to be dried in the process of the present invention may have been subjected beforehand to a first drying, if desired or if wished for, and in particular if the water content of the wet gas is too high. This first drying stage can be carried out according to any method well known to a person skilled in the art and for example by cooling the gas and bleeding off the condensed water or by passing over a membrane.

The process of the invention is generally carried out at a pressure of between atmospheric pressure and 10 MPa, preferably between atmospheric pressure and 5 MPa, and at ambient or moderate temperature, preferably at a temperature below the boiling point of water at the pressure under consideration.

The process of the invention is very particularly highly suitable for the drying of wet molecular hydrogen obtained by electrolysis with basic electrolyte and in particular electrolyte based on potassium hydroxide. The process for drying molecular hydrogen obtained by basic electrolysis in the presence of potassium hydroxide is particularly effective when the solid desiccant is a zeolite agglomerate as defined above, and for example a zeolite agglomerate based on zeolite 3A, 4A, 5A and/or 13X comprising kaolin as agglomeration binder, and preferably for a zeolite agglomerate based on zeolite 3A and/or 4A, having a kaolin binder.

The solid desiccant as described in the present invention, unlike the solid desiccants used today, is much more stable and resistant to basic attacks. This results in fewer contaminations of the gas to be dried by dust or others and in particular in a limited increase in the pressure drops in the desiccant systems, in particular the adsorbers, during their operation. Thus, the use for the drying of wet gases of a solid desiccant as described above is more effective and exhibits a major and certain economic advantage.

The invention is now illustrated using the examples which follow and which do not under any circumstances limit the invention, the scope of which is defined by the claims appended to the present description.

### Examples of Resistance to Potassium Hydroxide

The stabilities of the solid desiccants were evaluated according to the following test. 5 g of sieve, activated beforehand at 550° C. for 2 hours, are suspended in 100 ml of a 110 g/l potassium hydroxide solution in an Erlenmeyer flask.

The solid particles are left in contact with the solution for 1 hour, with manual stirring from time to time. The solutions are subsequently recovered by filtration for quantitative determination of the silicon and aluminium. The sieve is then dried at approximately 50° C. for 8 hours (without washing with water) and then activated in a ventilated oven at 230° C. for 3 hours (direct setpoint).

The following three samples are tested:
Sample 1 (comparative): Zeolite 4A agglomerate with 20% by weight of attapulgite binder (sample from Arkema, sold under the name NK 10 B 1.6/2.5 mm),
Sample 2 (invention): Zeolite 4A agglomerate with 20% by weight of kaolin binder (sample from Arkema, sold under the name SRA B 1.6/2.5 mm),
Sample 3 (invention): Zeolite 4A agglomerate with 20% by weight of kaolin binder zeolitized (2% of residual binder) with a 110 g/l aqueous sodium hydroxide (NaOH) solution at 95° C. for 2 hours, with an aqueous NaOH solution to zeolite agglomerate ratio by weight of 2.1.

An additional test (blank test) is carried out with the three samples not treated with potassium hydroxide. The test and the blank test are carried out on each of the samples, water adsorption (H50) and mechanical strength (MS) measurements.

The water adsorption capacity (H50), expressed in %, is determined by the ratio of the increase in the weight of 1 g of activated solid desiccant after saturation with water on conclusion of a residence of 24 hours in a closed chamber at 23±2° C., the relative humidity of which is equal to 50%, to the weight of reference activated solid desiccant (in this instance 1 g), multiplied by 100.

The mechanical strength (MS) measured (expressed in daN) corresponds to the grain crushing strength. The grain crushing mechanical strengths are determined with a grain crushing strength appliance sold by Vinci Technologies, according to Standards ASTM D 4179 and D 6175.

The H50 and MS (test and blank test) measurements for the three samples are recorded in Table 1 below.

TABLE 1

| | |
|---|---|
| Blank test | Test |

| | H50 (%) | MS (daN) | H50 (%) | MS (daN) |
|---|---|---|---|---|
| Sample 1 | 22.2 | 3.5 | 19.1 | 2.3 |
| Sample 2 | 21.8 | 5.8 | 19.5 | 5.7 |
| Sample 3 | 26.6 | 6.1 | 23.0 | 5.9 |

These results show that the zeolite agglomerates comprising a kaolin binder are more resistant to the treatment with potassium hydroxide, this being the case even when the kaolin binder has being partially zeolitized, while retaining acceptable adsorption capacities.

1. Use, for the drying of wet gas comprising traces of alkaline hydroxide, of a solid desiccant comprising at least one kaolin compound.

2. Use according to claim 1, in which the wet gas is chosen from nitrogen, oxygen, hydrogen, rare gases, carbon dioxide and their mixtures, and preferably the wet gas is hydrogen.

3. Use according to claim 1 or claim 2, in which the moisture content of the wet gas is of between 5 ppm by volume and 2% by volume.

4. Use according to any one of the preceding claims, in which the solid dessicant is chosen from activated aluminas, silica gels, molecular sieves and others, and also their mixtures in all proportions, and preferably from molecular sieves, and among the latter zeolite agglomerates, and more specifically zeolite agglomerates comprising crystals of zeolite(s) and at least one kaolin compound.

5. Use according to any one of the preceding claims, in which the solid desiccant is a zeolite agglomerate comprising from 70% to 99.99%, preferably from 70% to 99.9%, more preferably from 80% to 99.9%, by weight, limits included, of crystals of at least one zeolite chosen from zeolites of LTA type, zeolites of FAU type, zeolites of SOD type, zeolites of P type, and their mixtures, and preferably from zeolites 3A, 4A, 5A, 13X, and their mixtures, more preferably from zeolites 3A and 4A, and their mixtures.

6. Use according to any one of the preceding claims, in which the kaolin compound is a kaolin clay or a kaolin clay precursor and more particularly a clay chosen from kaolins, kaolinites, nacrites, dickites, halloysites and metakaolins, and their mixtures.

7. Use according to any one of the preceding claims, in which the kaolin compound is zeolitized, in all or in part, and preferentially in part.

8. Process for drying wet gas comprising traces of alkaline hydroxide, comprising at least one stage of bringing said wet gas into contact with a solid desiccant comprising at least one kaolin compound, defined in one of claims 1 to 7.

9. Process according to claim 8, characterized in that it is carried out at a pressure of between atmospheric pressure and 10 MPa, preferably between atmospheric pressure and 5 MPa, and at ambient or moderate temperature, preferably at a temperature below the boiling point of water at the pressure under consideration.

10. Process according to claim 8 or claim 9, for drying wet molecular hydrogen obtained by electrolysis with basic electrolyte and preferably drying wet molecular hydrogen obtained by electrolysis with electrolyte based on potassium hydroxide.

11. Process according to any one of claims 8 to 10, in which the solid dessicant is a zeolite agglomerate based on zeolite 3A, 4A, 5A and 13X, comprising kaolin as agglomeration binder, and preferably a zeolite agglomerate based on zeolite 3A and/or 4A, having a kaolin binder.
